(19) United States
(12) Patent Application Publication
(10) Pub. No.: US 2024/0092649 A1
(43) Pub. Date: Mar. 21, 2024

(54) SYSTEMS AND METHODS FOR SOLID-PHASE REACTIONS

(71) Applicant: Phoenix Tailings, Inc., Woburn, MA (US)

(72) Inventors: Thomas Anthony Villalon, Jr., Boston, MA (US); Henry Chase Hutcheson, Malden, MA (US)

(73) Assignee: Phoenix Tailings, Inc., Woburn, MA (US)

(21) Appl. No.: 18/463,992

(22) Filed: Sep. 8, 2023

Related U.S. Application Data
(60) Provisional application No. 63/405,056, filed on Sep. 9, 2022.

(51) Int. Cl. C01G 1/06; B01J 8/18; C01G 3/05; C01G 9/04; C01G 49/10

(52) U.S. Cl. CPC C01G 1/06; B01J 8/18; C01G 3/05; C01G 9/04; C01G 49/10

(57) ABSTRACT

The present disclosure is related to systems and methods for solid-phase reactions.

### RELATED APPLICATIONS

This application claims priority under 35 U.S.C. § 119(e) to U.S. Provisional Application No. 63/405,056, filed Sep. 9, 2022, and entitled “Systems and Methods for Solid-Phase Reactions,” which is incorporated herein by reference in its entirety for all purposes.

### GOVERNMENT SPONSORSHIP

This invention was made with government support under Contract No. DEAR0001500 awarded by the Advanced Research Projects Agency-Energy (ARPA-E). The government has certain rights in the invention.

### TECHNICAL FIELD

Systems and methods for solid-phase reactions are generally described.

### SUMMARY

The present disclosure is related to systems and methods for solid-phase reactions. Related systems and products are also described. The subject matter of the present invention involves, in some cases, interrelated products, alternative solutions to a particular problem, and/or a plurality of different uses of one or more systems and/or articles.

Certain aspects are related to methods.

In some embodiments, the method comprises mixing a first solid powder and a second solid powder within a volume, such that the first solid powder and the second solid powder react in a solid-phase reaction to form a product, wherein the volume contains less than 1 wt % of a liquid.

Certain aspects are related to methods of forming a rare earth metal halide. The method comprises, in some embodiments, heating a mixture comprising a first solid powder and a second solid powder, wherein: the first solid powder comprises a first salt, the first salt comprises a first type of cation and a first type of anion, the first type of cation is a rare earth metal cation, the second solid powder comprises a second salt, the second salt comprises a second type of cation and a second type of anion, the second type of anion is a halide, and the rare earth metal halide comprises the first type of cation and the second type of anion.

Certain aspects are related to methods of forming a metal halide. The method comprises, in some embodiments, mixing and heating a first solid powder and a second solid powder, wherein: the first solid powder comprises a first salt, the first salt comprises a first type of cation and a first type of anion, the first type of cation is a rare earth metal cation, an aluminum cation, or a transition metal cation, the second solid powder comprises a second salt, the second salt comprises a second type of cation and a second type of anion, the second type of anion is a halide, the mixing is performed with the use of a high-viscosity mixer, and the metal halide comprises the first type of cation and the second type of anion.

In some embodiments, a method of forming a metal halide comprises heating a mixture comprising a first solid powder and a second solid powder, wherein: the first solid powder comprises a first salt, the first salt comprises a first type of cation and a first type of anion, the second solid powder comprises a second salt, the second salt comprises a second type of cation and a second type of anion, the second type of anion is a halide, the first salt comprises a third type of cation, the third type of cation is a rare earth metal cation, an aluminum cation, or a transition metal cation, the metal halide comprises the first type of cation and the second type of anion, and less than or equal to at % of the third type of cation initially present in the first salt is present in the metal halide.

Certain aspects are related to reactors.

In some embodiments, the reactor comprises a volume containing a first solid powder and a second solid powder, wherein: the volume contains less than 1 wt % liquid, and the first solid powder and the second solid powder are configured to react in a solid-phase reaction to form a product.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B are, in accordance with certain embodiments, cross-sectional schematic illustrations showing a reactor.

FIGS. 2-3 are, in accordance with certain embodiments, cross-sectional schematic illustrations showing reactors comprising impellers having various configurations.

FIGS. 4-5 are, in accordance with certain embodiments, schematic illustrations showing a reactor, an impeller, and a vane.

FIG. 6 is, in accordance with certain embodiments, a schematic illustration of an impeller.

### DETAILED DESCRIPTION

Systems and methods for solid-phase reactions are generally described. Certain aspects of the present disclosure are directed to the discovery that the use of a metal-containing solid powder and a solid reagent powder in a reactor can allow for a solid-phase reaction between the solid powders to take place to form a product (e.g., a water soluble metal halide). The reactor and/or associated components (e.g. mixer, heater, etc.), in certain embodiments, may have a particularly advantageous design(s) for carrying out effective solid-phase reactions between the solid powders. For example, some embodiments are related to the discovery that effective solid-phase reactions can be achieved via a one-step process involving simultaneous mixing and heating of the metal-containing solid powder and solid reagent powder under inert atmosphere, in the presence of little to no liquid. Certain embodiments are related to the discovery that the process can provide, in certain instances, one or more of a variety of operational advantages including, but not limited to, selective accumulation and recovery of target metals from the metal-containing solid powder, enhanced process efficiency, lack of a need for liquid solvent, and the like. It has also been recognized, within the context of the present disclosure, that the use of solid powders having relatively small sizes may allow for efficient mixing and effective solid-phase reaction to take place between the solid powders. Additionally, the process may advantageously allow for conversion of metals from a non-processable form or less processable form (e.g., such as natural ore powder) to a more processible form (e.g., such as a water soluble halide) that can be readily recovered via one or more downstream processes.

In some embodiments, methods are described. The methods can involve, in some embodiments, mixing a first solid powder (e.g., a metal-containing powder) and a second powder (e.g., a reagent in the form of a solid powder) within a volume. In some embodiments, the mixing is performed in a manner that facilitates continuous mixing and/or the development of crossflow within the solid powders. For instance, the mixing may be performed with the use of a high-viscosity mixer. In some embodiments, the first solid powder and the second solid powder may be simultaneously heated while being mixed. It also possible for the first solid powder and the second solid powder to be heated without being mixed. The mixture of solid powders, in certain embodiments, react to form a product (e.g., a water-soluble product) via a solid-phase reaction.

Some methods relate to the formation of metal halides, such as rare earth metal halides, aluminum halides, and/or transition metal halides. Advantageously, such halides may have a relatively high solubility in one or more solvents. This may facilitate recovery of the metal from a material in which it is initially present. For instance, a material initially containing a target metal that is in a form insoluble in a certain solvent may be reacted to form a target metal halide that is soluble in that solvent. Subsequently, the target metal halide may then be dissolved in that solvent and then the target metal may be recovered upon removal of that solvent therefrom.

It is also possible for a target metal to be recovered by performing a process similar to the above but in which a metal other than the target metal is reacted to form a metal halide. For instance, a material initially including both a target metal and a non-target metal may undergo a reaction such that a halide of the non-target metal is formed. The halide of the non-target metal may be removed from the resultant material by dissolving the non-target metal halide in the solvent, leaving behind the target metal.

In some embodiments, a metal halide may be formed from two solid powders, one of which comprises a metal cation and the other of which comprises a halide anion. The metal halide that is formed may comprise the metal cation and the halide anion. As described above, the metal halide may be formed upon heating and/or mixing the two solid powders. The heat and/or mixing may cause the two solid powders to react such that a salt comprising the metal cation of the first salt and the halide anion of the second salt is formed.

In some embodiments, systems for solid-phase reactions are also described. For example, reactors capable of being employed for carrying out the above-referenced solid-phase reaction between the first solid powder and the second solid powder are described herein.

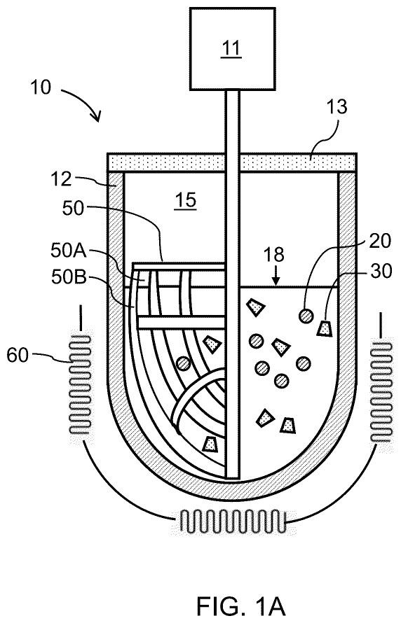

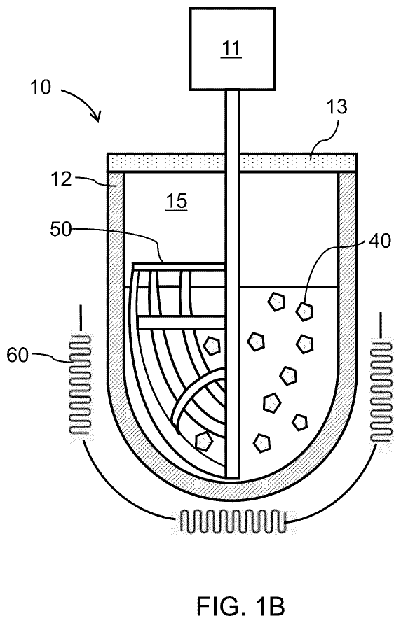

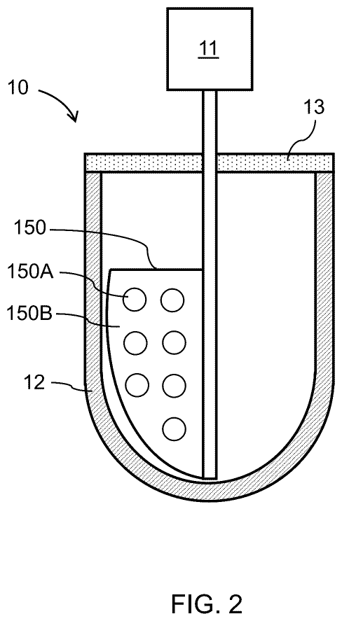

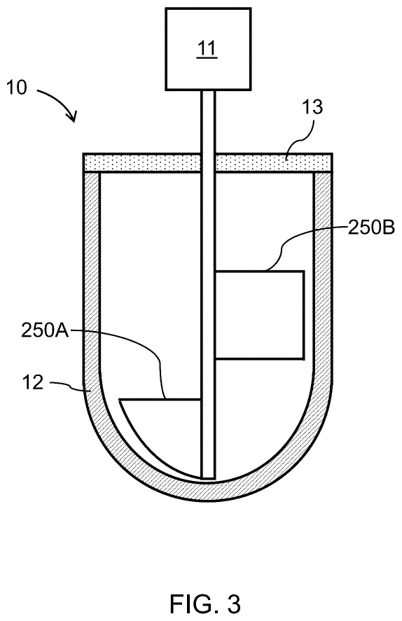

FIGS. 1A-1B are schematic illustrations of one such reactor that can be used to react a first solid powder with a second powder in a solid-phase reaction. FIGS. 2-3 are schematic illustrations of reactors having alternative configurations. These figures are referred to throughout the disclosure below.

In certain embodiments, reactors are described. The reactor may comprise and/or be associated with any of a variety of appropriate components, e.g., such a reaction volume, a mixer, a heater, and the like. FIG. 1A illustrates one non-limiting embodiment of a reactor. As shown in FIG. 1A, reactor 10 may comprise volume 15, mixer 50, and heater 60. Specifics about each component are described in more detail below.

In some embodiments, the reactor comprises a vessel wall and a volume within the wall. For example, as shown in FIG. 1A, reactor 10 comprises vessel wall 12 and volume 15 within vessel wall 12. In some embodiments, the reactor may comprise a volume containing a first solid powder and a second solid powder. For example, as shown in FIG. 1A, reactor 10 may comprise volume 15 containing first solid powder 20 and second solid powder 30. As described in more detail below, the first solid powder and the second solid powder, in accordance with certain embodiments, are configured to react in a solid-phase reaction to form a product.

In some embodiments, the first solid powder comprises a plurality of solid particles. A variety of first solid powders can be used in accordance with the present disclosure. In some embodiments, a first solid powder comprises a first salt. The first salt may comprise a first type of cation and a first type of anion. Such salts may comprise further types of cations and/or anions (e.g., a second type of cation, a second type of anion, third or higher type(s) of cations, third or higher type(s) of anions). In first salts comprising multiple types of cations, it is possible for either a target metal or a cation of another type to be configured to form and/or capable of being incorporated into a halide salt. In instances in which the cation of the other type is configured to form and/or capable of being incorporated into a halide salt, the target metal may be incorporated into the halide salt in a relatively low amount.

According to certain embodiments, the first solid powder may comprise a target-metal-containing powder. For instance, a first solid powder may comprise a salt for which the first type of cation is a target metal cation. As used herein, “target-metal-containing powder” is a powder that contains one or more target metal(s). In some embodiments, the first solid powder comprises a plurality of target-metal-containing powders. A variety of target-metal-containing powders can be processed according to various embodiments of the present disclosure to recover various target metals, as described in more detail below.

As used herein, “target metal” refers to metal that is (1) in a zero oxidation state or (2) is in a non-zero oxidation state form within a compound other than a halogen compound. For example, metallic platinum would be considered a target metal because it is a metal in a zero oxidation state. The platinum within platinum chloride would not, on the other hand, be considered a target metal because the platinum in platinum chloride is in a halogen compound. Non-limiting examples of non-zero oxidation states include 1+, 2+, 3+, and 4+.

In certain embodiments, the target metal and/or a type of cation present in a first salt (e.g., a target metal cation, a non-target metal cation) is in a non-zero oxidation state form within a compound other than a phosphate. In certain embodiments, the target metal and/or the type of cation present in the first salt is in a non-zero oxidation state form within a compound other than an arsenide. In certain embodiments, it can be advantageous to use methods described herein to process powders in which the target metal(s) and/or one or more of the types of cation present in the first salt is present in a non-zero oxidation state, in the form of a sulfide and/or in the form of an oxide. In some embodiments, the first solid powder comprises a natural ore powder. Non-limiting examples of first solid powders include sulfide and/or oxide ore bodies containing one or more target metals (e.g., transition metals (e.g., zinc, lead, copper, and/or cobalt), aluminum, and/or rare earth metals (e.g., lanthanides)). For instance, a first solid powder may comprise a salt comprising a first type of cation (and/or a higher type of cation) and a sulfide and/or an oxide (i.e., a second type of anion that is a sulfide or an oxide, a second type of anion that is a sulfide and a third type of cation that is an oxide).

In some embodiments, the one or more target metals and/or a type of cation present in a first salt comprises a rare earth metal. The “rare earth metals,” as used herein, are the lanthanides, yttrium, and scandium. The “lanthanides,” as used herein, are lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

In some embodiments, the one or more target metals and/or a type of cation present in the first salt comprises a transition metal. The “transition metals,” as used herein, are scandium (Sc), yttrium (Y), lanthanum (La), actinium (Ac), titanium (Ti), zirconium (Zr), hafnium (Hf), rutherfordium (Rf), vanadium (V), niobium (Nb), tantalum (Ta), dubnium (db), chromium (Cr), molybdenum (Mo), tungsten (W), seaborgium (Sg), manganese (Mn), technetium (Tc), rhenium (Re), bohrium (Bh), iron (Fe), ruthenium (Ru), osmium (Os), hassium (Hs), cobalt (Co), rhodium (Rh), iridium (Ir), meitnerium (Mt), nickel (Ni), palladium (Pd), platinum (Pt), darmstadtium (Ds), copper (Cu), silver (Ag), gold (Au), roentgenium (Rg), zinc (Zn), cadmium (Cd), mercury (Hg), and copernicium (Cn).

In some embodiments, the one or more target metals and/or a type of cation present in the first salt comprises aluminum (Al).

In some embodiments, the one or more target metals and/or a type of cation present in the first salt comprises an alkali metal and/or an alkaline earth metal. The term “alkali metal” is used herein to refer to the following six chemical elements of Group 1 of the periodic table: lithium (Li), sodium (Na), potassium (K), rubidium (Rb), cesium (Cs), and francium (Fr). The term “alkaline earth metal” is used herein to refer to the six chemical elements in Group 2 of the periodic table: beryllium (Be), magnesium (Mg), calcium (Ca), strontium (Sr), barium (Ba), and radium (Ra).

Non-limiting examples of materials comprising target metals and first solid powders include lanthanide oxides, iron oxides (e.g., iron(III) oxide), chromium oxides, vanadium oxides, bauxite, zinc sulfide aluminosilicates, zinc oxides, zinc sulfides, red mud, rare earth magnet scrap (e.g., synthetic rare earth magnet scrap), and chalcopyrite.

The first solid powder may comprise a plurality of solid particles having any of a variety of sizes. In some embodiments, at least 50 vol % (e.g., or at least 60 vol %, at least 70 vol %, at least 80 vol %, at least 90 vol %, or all) of the first solid powder is made up of solid particles having largest cross-sectional dimensions of greater than or equal to 1 μm, greater than or equal to 5 μm, greater than or equal to 10 μm, greater than or equal to 15 μm, greater than or equal to 20 μm, greater than or equal to 50 μm, greater than or equal to 100 μm, greater than or equal to 500 μm, or greater than or equal to 1 mm. In some embodiments, at least 50 vol % (e.g., at least 60 vol %, at least 70 vol %, at least 80 vol %, at least 90 vol %, or all) of the first solid powder is made up of solid particles having largest cross-sectional dimensions of less than or equal to 5 mm, less than or equal to 1 mm, less than or equal to 500 μm, less than or equal to 100 μm, less than or equal to 50 μm, less than or equal to 20 μm, less than or equal to 15 μm, less than or equal to 10 μm, or less than or equal to 5 μm. Combinations of the above-referenced ranges are possible (e.g., greater than or equal to 1 μm and less than or equal to 5 mm, greater than or equal to 10 μm and less than or equal to 1 mm, or greater than or equal to Rm and less than or equal to 500 μm). Other ranges are also possible.

In some embodiments, the second solid powder comprises a plurality of solid particles. A variety of second solid powders can be used in accordance with the present disclosure. In some embodiments, a second solid powder comprises a second salt. The first salt may comprise a second type of cation (e.g., a type of cation different from a type of cation present in the first solid powder) and a second type of anion (e.g., a type of anion different from a type of anion present in the first solid powder). Such salts may comprise further types of cations and/or anions (e.g., a third type of cation, a third type of anion, fourth or higher type(s) of cations, fourth or higher type(s) of anions). In some embodiments, a second salt consists of and/or consists essentially of types of cations and types of anions that are not found in a first salt. Similarly, in some embodiments a first salt consists of and/or consists essentially of types of cations and types of anions that are not found in a second salt. It is also possible for one or more types of cations and/or anions to be present in both a first salt and a second salt.

In some embodiments, the second solid powder comprises one or more solid reagent(s) capable of reacting with at least a portion of the first solid powders. In some cases, the one or more solid reagent(s) may be capable of reacting with one or more target metals contained within the first solid powders. A variety of second solid powders can be used in accordance with the present disclosure.

In some embodiments, the second type of cation comprises an alkali metal cation and/or an alkaline earth metal cation.

In some embodiments, the second type of cation comprises a first-row transition metal cation. The “first-row transition metals,” as used herein, are Sc, Ti, V, Cr, Mn, Fe, Co, Ni, Cu, and Zn.

In some embodiments, the second type of cation comprises a proton (H).

In some embodiments, the second type of cation comprises a polyatomic cation. Non-limiting examples of suitable polyatomic cations include ammonium, guanidium, and phosphonium.

In some embodiments, the second solid powder comprises one or more halogen-containing materials. A “halogen-containing material,” as used herein, is any material that comprises a halogen atom (which may or may not be in ionic form, and may be within a solid salt or in ionized form). For the purposes of the present disclosure, the “halogen” elements are fluorine (F), chlorine (Cl), bromine (Br), iodine (I), astatine (At), and tennessine (Ts). In one embodiment, the halogen may be present as a part of a halogen salt, such as in the form of a halide. In certain embodiments, the halogen-containing material may be a halogen salt comprising a cation and a halide. In one embodiment, the halogen salt comprises a metal cation and a halide. The halogen salt, according to some embodiments, may include one or more of an alkali metal halide and/or an alkaline earth metal halide. Alternatively or additionally, in some embodiments, the halogen salt may include one or more of a transitional metal halide (e.g., a first-row transition metal halide).

Non-limiting examples of a halogen-containing material comprising a metal halide include magnesium chloride, calcium chloride, hydrochloric acid, sodium fluoride, calcium chloride, ferric chloride, calcium bromide, and potassium bromide. Alternatively or additionally, the halogen salt may include one or more of a non-metal halide (e.g., it may be a halogen-containing acid, such as a hydrohalic acid, and/or may comprise a polyatomic cation). In one set of embodiments, the halogen salt comprises ammonium bromide and/or ammonium chloride.

The second solid powder may comprise a plurality of solid particles having any of a variety of sizes. In some embodiments, at least 50 vol % (e.g., or at least 60 vol %, at least 70 vol %, at least 80 vol %, at least 90 vol %, or all) of the second solid powder is made up of solid particles having largest cross-sectional dimensions of greater than or equal to 1 μm, greater than or equal to 5 μm, greater than or equal to 10 μm, greater than or equal to 15 μm, greater than or equal to 20 μm, greater than or equal to 50 μm, greater than or equal to 100 μm, greater than or equal to 500 μm, or greater than or equal to 1 mm. In some embodiments, at least 50 vol % (e.g., at least 60 vol %, at least 70 vol %, at least 80 vol %, at least 90 vol %, or all) of the of the second solid powder is made up of solid particles having largest cross-sectional dimensions of less than or equal to 5 mm, less than or equal to 1 mm, less than or equal to 500 μm, less than or equal to 100 μm, less than or equal to 50 μm, less than or equal to 20 μm, less than or equal to 15 μm, less than or equal to 10 μm, or less than or equal to 5 μm. Combinations of the above-referenced ranges are possible (e.g., greater than or equal to 1 μm and less than or equal to 5 mm, greater than or equal to 10 μm and less than or equal to 1 mm, or greater than or equal to 20 μm and less than or equal to 500 μm). Other ranges are also possible.

Non-limiting exemplary combinations of first and second salts that may be subject to heating and/or mixing and potential heating and reactor conditions are listed below in Table 1.

TABLE 1
Exemplary combinations of first and second salts.

| | | | | Temperature | |
|---|---|---|---|---|---|
| | First | Second | Second | to Which | |
| First Type of | Type of | Type of | Type of | Mixture Is | Reactor |
| Cation | Anion | Cation | Anion | Heated | Conditions |
| Sc, Y, La, Pr, | Oxide | Ca²⁺, | Cl⁻, F⁻, | 250° C.-500° C. | Unsealed, lidded |
| Nd, Pm, Sm, | | Mg²⁺, H⁺, | and/or Br⁻ | | reactor or open |
| Eu, Gd, Dy, | | and/or | | | reactor |
| Ho, Er, Tm, | | NH₄⁺ | | | |
| Yb, and/or Lu | | | | | |
| cation | | | | | |
| Fe, Co, V, | Oxide | Ca²⁺ | Cl⁻ | 250° C.-500° C. | Unsealed, lidded |
| and/or Cu | | | | | reactor or open |
| cation | | | | | reactor |
| Transition | Oxide | NH₄⁺ | Cl⁻ | 250° C.-500° C. | Unsealed, lidded |
| metal cation | | | | | reactor |
| Transition | Sulfide | Ca²⁺, | Cl⁻ | 250° C. | Unsealed, lidded |
| metal cation | | Mg²⁺, | | | reactor |
| | | and/or | | | |
| | | NH₄⁺ | | | |
| Alkaline earth | Oxide | Ca²⁺, | Cl⁻ | 250° C. | Unsealed, lidded |
| metal oxide | | Mg²⁺, | | | reactor |
| | | and/or | | | |
| | | NH₄⁺ | | | |

Without wishing to be bound by any particular theory, it is believed that first salts that are particularly amenable to undergoing the reactions described herein (e.g., to forming a halide) may comprise a first type of cation that has identically one oxidation state in the first salt and/or that has mostly one oxidation state in the first salt (with Pr being a notable exception). It is believed that the presence of multiple easily accessible oxidation states for a first type of cation may result in a reaction that changes the oxidation state of the first type of cation but that does not result in the formation of a halide comprising the first type of cation.

In some embodiments, at least a portion of at least one type of cation initially present in a first salt is retained in the first solid powder subsequent to the heating the first and second solid powders. This retention may be relatively high. For instance, in some such embodiments, a reaction described herein results in the formation of a metal halide that includes a relatively low amount of a target metal and/or a metal initially present as a cation in a first salt. Less than or equal to 30 at %, less than or equal to 25 at %, less than or equal to 20 at %, less than or equal to 15 at %, less than or equal to 12.5 at %, less than or equal to 10 at %, less than or equal to 7.5 at %, less than or equal to 5 at %, less than or equal to 2 at %, less than or equal to 1 at %, less than or equal to 0.75 at %, less than or equal to 0.5 at %, less than or equal to 0.2 at %, or less than or equal to 0.1 at % of the target metal and/or metal initially present as a cation in the first salt may be incorporated into the metal halide upon heating first and second solid powders. In some embodiments, greater than or equal to 0 at %, greater than or equal to 0.1 at %, greater than or equal to 0.2 at %, greater than or equal to 0.5 at %, greater than or equal to 0.75 at %, greater than or equal to 1 at %, greater than or equal to 2 at %, greater than or equal to 5 at %, greater than or equal to 7.5 at %, greater than or equal to 10 at %, greater than or equal to 12.5 at %, greater than or equal to 15 at %, greater than or equal to 20 at %, or greater than or equal to 25 at % of the target metal and/or metal initially present as a cation in the first salt may be incorporated into the metal halide upon heating first and second solid powders. In some embodiments, exactly 0 at % of the target metal and/or metal initially present as a cation in the first salt is incorporated into the metal halide. Combinations of the above-referenced ranges are also possible (e.g., less than or equal to 30 at % and greater than or equal to 0 at %, or less than or equal to 15 at % and greater than or equal to 0 at %). Other ranges are also possible.

When a first salt comprises three or more types of cations, each type of cation other than that of the target metal may independently be incorporated into the metal halide in an amount in one or more of the ranges provided above. It is also possible for all of the types of cations other than that of the target metal to together be incorporated into the metal halide in an amount in one or more of the ranges provided above.

The first solid powder and the second solid powder may be present in the reactor in any appropriate amount. For example, as shown in FIG. 1A, first solid powder 20 and second solid powder 30 may be present in volume 15 in an amount such that the solid powders fill up to height 18 of volume 15. For example, the first solid powder and the second solid powder may together occupy at least 10 vol % (e.g., at least 20 vol %, at least vol %, at least 50 vol %, at least 75 vol %, at least 80 vol %, or more) and/or no more than 85 vol % (e.g., no more than 80 vol %, no more than 75 vol %, no more than 50 vol %, no more than 30 vol %, no more than 20 vol %, or less) of the volume of the reactor. Combinations of the above-referenced ranges are possible (e.g., at least 10 vol % and no more than 85 vol %, at least 30 vol % and no more than 80 vol %, at least 50 vol % and no more than 75 vol %, etc.). Other ranges are also possible.

The reaction volume (e.g., the volume in which heating and/or mixing of solid powders takes place, a volume contained by a reactor), according to some embodiments, may contain a small amount of, if any, liquid, such that the volume maintains a substantially dry environment. In one set of embodiments, the volume does not contain any liquid (such that the volume contains 0 wt % of liquid as measured relative to all contents of the volume). In accordance with some embodiments, a small amount of, if any, liquid is present in the volume. In some embodiments, the volume contains less than or equal to 5 wt %, less than or equal to 4 wt %, less than or equal to 2 wt %, less than or equal to 1 wt %, less than or equal to 0.8 wt %, less than or equal to 0.6 wt %, less than or equal to 0.5 wt %, less than or equal to 0.2 wt %, less than or equal to 0.1 wt %, less than or equal to 0.05 wt %, less than or equal to 0.01 wt % (and/or down to 0.001 wt %, down to 0.0001 wt %, or down to 0.00001 wt %, or down to 0 wt %) of liquid (as measured relative to all contents of the volume). Combinations of the above-referenced ranges are possible (e.g., less than or equal to 5 wt % and down to 0.00001 wt %, less than or equal to 5 wt % and down to 0 wt %, less than or equal to 0.1 wt % and down to 0.00001 wt %, or less than or equal to 0.01 wt % and down to 0.00001 wt %). Other ranges are also possible.

In some embodiments, the reaction volume (e.g., the volume in which heating and/or mixing of solid powders takes place, a volume contained by a reactor) may contain an inert gas described elsewhere herein. According to some embodiments, the inert gas is configured to occupy any volume not occupied by the first solid powder and the second solid powder. For example, as shown in FIG. 1A, volume 15 may contain an inert gas (not shown). The inert gas may occupy any remaining volume not occupied by first solid powder 20 and second solid powder 30, e.g., such as the volume above line 18. According to certain embodiments, the reactor may have a particular configuration and/or may comprise particular components that are advantageous for use in a solid-phase reaction between a first solid powder and a second solid powder. For example, in some embodiments, a mixer may have a particular geometry configured to facilitate efficient mixing of the first solid powder and the second solid powder within the volume may be employed. The efficient mixing may comprise continuous mixing and/or a high degree of crossflow.

The mixer may comprise a motor and one or more impeller(s) connected (e.g., attached) to the motor. In some embodiments, the motor is an electric motor. For example, as shown in FIG. 1A, reactor 10 comprises a mixer comprising impeller 50 connector to electric motor 11. In some embodiments, the motor is configurated to control the rotational speed and/or direction of rotation of the impeller.

In some embodiments, the impeller may have a particularly advantageous configuration or geometry that allows for efficient mixing of the first solid powder and the second solid powder within the volume (during the course of the solid-phase reaction). The impeller, in accordance with certain embodiments, may be capable of inducing efficient mixing of the solid powders by rotating the impeller in one or both directions, driving turbulent flow and mixing of the solid powders, and preventing the solid powders from agglomerating and/or breaking up agglomerations (if formed).

One non-limiting example of an impeller that results in particularly desirable mixing is an impeller that comprises a high-viscosity mixer. Without wishing to be bound by any particular theory, it is believed that high-viscosity mixers desirably promote a high degree of crossflow, which promotes a desirably high degree of mixing. Two non-limiting examples of high-viscosity mixers include mixers comprising tilted vanes and ribbon mixers. Such mixers may be configured to both push powders down and lift powders up, which is believed to promote advantageous crossflow.

As another example, in one set of embodiments, the impeller has a configuration comprising a plurality of openings formed between a plurality of horizontal and vertical rods or bars. For example, as shown in FIG. 1A, impeller 50 may comprise a plurality of openings 50A formed between a plurality of horizontal and vertical rods or bars 50B. In some cases, at least a portion of the plurality of openings may have sizes (e.g., largest cross-sectional dimensions) larger than the sizes of individual particles in the first solid powder and the second solid powder, e.g., such that the particles may travel through the holes or opening as the impeller rotates during mixing.

While FIG. 1A shows one set of embodiments of an impeller having a particular configuration, it should be understood that the disclosure is not so limited, and that in other embodiments, the impeller may have any of a variety of appropriate configurations. For example, FIGS. 2-3 illustrate additional non-limiting examples of impellers capable of facilitating mixing between the first solid powder and the second solid powder.

For example, in one set of embodiments, the impeller may comprise a plurality of holes (e.g., thru-holes) or openings distributed across a body of the impeller. For example, as shown in FIG. 2, impeller 150 may comprise a plurality of holes or openings 150A distributed across body 150B of impeller 150A. The holes or opening may be distributed in any appropriate fashion (e.g., uniformly or non-uniformly) across the body of the impeller. In some instances, at least a portion of the plurality of holes or openings may have sizes (e.g., largest cross-sectional dimensions) larger than the sizes of individual particles in the first solid powder and the second solid powder, e.g., such that the particles may travel through the holes or opening as the impeller rotates during mixing.

For example, in another set of embodiments, the impeller may comprise a plurality of impeller blades arranged in a particular configuration that allows for efficient mixing between the first solid powder and the second solid powder. For example, according to one set of embodiments, the impeller may comprise a first impeller blade and a second impeller blade arranged in a non-coplanar fashion. For example, as shown in FIG. 3, impeller 250 may comprise first impeller blade 250A and a second impeller blade 250B arranged in a non-coplanar fashion. In some embodiments, the center axis of the plurality of impeller blades may be spaced at least 30 degrees (e.g., at least 40 degrees, at least 60 degrees, at least 90 degrees) and/or up to 120 degrees (e.g., up to 150 degrees, or up to 180 degrees, or more) apart from each other. In some embodiments, the plurality of impeller blades may be spaced apart from each other in a vertical direction (defined relative to gravity). For example, as shown in FIG. 3, first impeller blade 250A may be spaced apart from second impeller blade 250B in a vertical direction at any suitable distance.

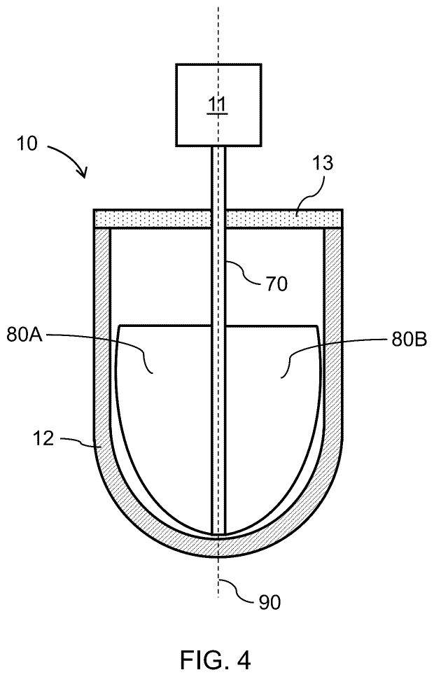

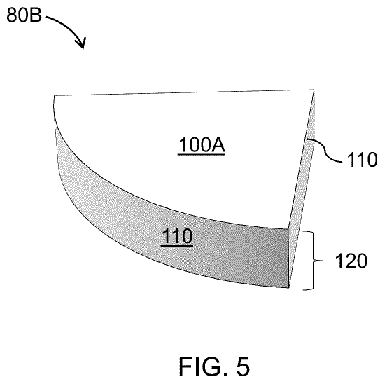

In some embodiments, an impeller comprises a plurality of tilted vanes. The impeller may further comprise a shaft, and the vanes may be tilted with respect to the shaft. It is also possible for the vanes to be tilted with respect another direction (e.g., with respect to gravity). FIGS. 4 and 5 show one non-limiting example of an impeller comprising a plurality of tilted vanes. In FIG. 4, impeller 350 comprises shaft 70 and vanes 80A and 80B. As also shown in FIG. 4, the shaft 70 has long axis 90. The long axis 90 is the longest principal axis of the shaft 70.

FIG. 5 shows a perspective view of vane 80B. As can be seen in FIG. 5, vane 80B can be conceptualized as being bounded by two planar surfaces 100A and 100B (not shown) and surfaces 110 perpendicular to planar surfaces 100A and 100B that connect planar surfaces 100A and 100B. The planar surfaces may be separated by thickness 120. In some embodiments, a vane is not bounded by any planar surfaces. Such vanes may still include two opposing surfaces that have relatively high surface areas and that are separated by a thickness that is relatively small in comparison to the square root of the surface area of these opposing surfaces. In such embodiments, thickness 120 is the maximum distance between these opposing surfaces.

When a vane is tilted, the angle between the direction along which thickness 120 points (i.e., the direction perpendicular to planar surfaces 100A and 100B) and the direction along which long axis 90 points has a value other than 0° and a value other than 90°. When an impeller comprises more than one tilted vane, each vane may have the same angle of tilt (i.e., the same angle between the direction along which the long axis of the shaft points and the direction along which the thickness of the vane points) or two or more vanes may have different angles of tilt from each other.

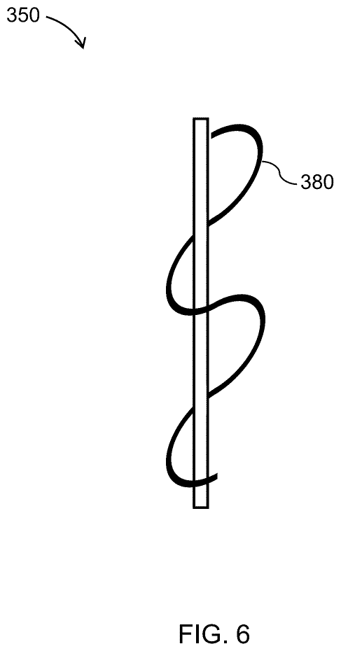

In some embodiments, an impeller comprises a vane that has a helical shape. Such impellers may be present in ribbon mixers. It is also possible for an impeller to comprise two or more vanes that each take the form of a helix. In such instances, the helix and/or helices may have any suitable pitches and/or distances from each other. Where two or more helical vanes are present, the helical vanes may be identical to each other or may differ in one or more ways (e.g., pitch). FIG. 6 shows one non-limiting example of an impeller 350 comprising a helical vane 380.

In some embodiments, the impeller comprises a central axis that is centered in the reaction volume. The impeller, according to some embodiments, is constructed and arranged to create an axial flow and ensure adequate mixing of the solid powders. The impeller may comprise any appropriate type of impeller blade. Non-limiting examples of impellers include pitched blade impellers and helical ribbon impellers. The impeller may have any appropriate dimensions. In some embodiments, the impeller has a maximum cross-sectional dimension that is at least ¼, at least ⅜, at least ½, or more, and/or up to ¾, up to 13/16, or up to ⅞ of the maximum cross-sectional dimension (e.g., diameter) of the reactor.

In some embodiments, the reactor comprises a heater configured to heat the volume to a temperature (e.g., to a temperature described herein). The heater may include any of a variety of heating systems (e.g., such as an internal or an external heating systems). Any of a variety of heaters may be employed, including, but not limited to, a Peltier heater, a heating jacket and/or coil, a resistive heater, electrical elements, gas burners, a heating torch, and/or a heat exchanger. In some embodiments, radial heat sources may be employed to achieve uniform heating on one or more external surfaces (e.g., every external surface) of the reactor (with the exception of the top surface). FIG. 1A illustrates a non-limiting example of an external heater, illustrated as a resistive heater. As shown, reactor 10 may comprise heater 12 configured to heat volume 15 to a temperature described elsewhere herein.

In some embodiments, the reactor may include any of a variety of additional components. Examples of additional components include, but are not limited to, various sensors, a cover or lid, gassing lines, baffles, sparging tubes, etc. For example, as shown in FIG. 1A, reactor 10 may comprise cover 13 configured to seal volume 15. In some cases, the reactor may include one or more gassing lines configured to introduce inert gas into the volume. The reactor, in certain embodiments, may include one or more baffles configured to ensure adequate mixing of the solid powders and/or to drive flow of the solid powders along desired flow paths. Alternatively or additionally, the reactor may include one or more sparger tubes configured to flow inert gases into the reaction volume such that the solid powders may be fluidized within the reaction volume.

In some embodiments, the components (e.g., impeller, vessel wall, etc.) of the reactor may be fabricated from materials capable of withstanding the high system temperatures. For example, appropriate materials may include metals, metal alloys, and/or high-temperature plastics or polymers. Specific non-limiting example of such materials may include nickel-based alloys, stainless steel alloys, glass and/or ceramic lined metal (e.g., alumina, silica, or glass lined metal).

In some embodiments, the components (e.g., impeller, vessel wall, etc.) of the reactor may comprise a material that is a refractory material, such as Hastelloy.

In some embodiments, the components (e.g., impeller, vessel wall, etc.) of the reactor may comprise a passivated oxide layer. Without wishing to be bound by any particular theory, it is believed that the presence of a passivated oxide layer may desirably reduce and/or prevent reaction between the reactor and one or more components contacting the reactor (e.g., one or more gases present during a heating and/or mixing step, one or more solid powders present during a heating and/or mixing step, one or more components present in a volume contained thereby, such as a reaction volume contained thereby).

In some embodiments, portions of the reactor in contact with the first solid powder and/or the second solid powder may be lined with ceramics and/or a chemical resistant polymer. Without wishing to be bound by any particular theory, lining portions of the reactor may advantageously prevent undesirable side reactions from occurring during solid-phase reactions. In some embodiments, the reactor may be formed from materials capable of withstanding an operating temperature and/or pressure described herein, such as a pressure of up to 20 atmospheres absolute.

In some embodiments, methods are provided. In some embodiments, a method comprises heating a first solid powder and a second solid powder. In one set of embodiments, the method comprises mixing a first solid powder and a second solid powder within a volume of a reactor. FIGS. 1A-1B can be used to illustrate an example of one such embodiment. As shown in FIG. 1A, first solid powder 20 and second solid powder 30 may be mixed within volume 15. The first solid powder and the second solid powder may be mixed using any appropriate types of mixers and/or impellers described herein. For example, as shown in FIG. 1A, impeller 50 has been employed to mix first solid powder 20 and second solid powder 30 within volume 15.

The mixture of first solid powder and the second solid powder may be contained within the volume (e.g., a volume contained by a reactor, such as a reaction volume) in any of a variety of appropriate molar ratios. For example, in some embodiments, a molar ratio of the reactant (e.g., a first type of cation, a target metal) in first solid powder to the reactant in the second solid powder (e.g., a halide) may be greater than or equal to 1:1, greater than or equal to 5:1, greater than or equal to 10:1, greater than or equal to 25:1, greater than or equal to 50:1, or greater than or equal to 75:1. In some embodiments, a molar ratio of the reactant in the first solid powder to the reactant in the second solid powder may be less than or equal to 100:1, less than or equal to 75:1, less than or equal to 50:1, less than or equal to 25:1, less than or equal to 10:1, or less than or equal to 5:1. Combinations of the above-referenced ranges are possible (e.g., greater than or equal to 1:1 and less than or equal to 100:1, greater than or equal to 5:1 and less than or equal to 75:1, or greater than or equal to 10:1 and less than or equal to 50:1). Other ranges are also possible.

In some embodiments, the first solid powder and the second solid powder may have a particular combination of sizes that is advantageous for effective mixing. For example, the second solid powder may have a size (e.g., a largest cross-sectional dimension) that is comparable to the size (e.g., a largest cross-sectional dimension) of the first solid powder. Without wishing to be bound by any particular theory, it is hypothesized that employing first and second solid powders having comparable sizes may increase the size homogeneity and contact surface area of the powders, which may then lead to more efficient powder mixing and drive a more effective solid-phase reaction between the solid powders.

For example, in some embodiments, at least 50 vol % (e.g., or at least 60 vol %, at least 70 vol %, at least 80 vol %, at least 90 vol %, or all) of the plurality of particles in the second solid powder may have a largest cross-sectional dimension that is less than or equal to 10 times (e.g., or less than or equal to 8 times, less than or equal to 5 times, less than or equal to 3 times, less than or equal to 2 times, less than or equal to 1 time, less than or equal to 0.5 times, less than or equal to 0.2 times, or less) the largest cross-sectional dimension of at least 50 vol % (e.g., or at least 60 vol %, at least 70 vol %, at least 80 vol %, at least 90 vol %, or all) of the plurality of particles in the first solid powder. In some embodiments, at least 50 vol % (e.g., or at least 60 vol %, at least 70 vol %, at least 80 vol %, at least 90 vol %, or all) of the plurality of particles in the second solid powder may have a largest cross-sectional dimension that is greater than or equal to 0.1 times (e.g., greater than or equal to 0.2 times, greater than or equal to 0.5 times, greater than or equal to 1 time, greater than or equal to 2 times, greater than or equal to 3 times, greater than or equal to 5 times, greater than or equal to 8 times, or more) the largest cross-sectional dimension of at least 50 vol % (e.g., or at least 60 vol %, at least 70 vol %, at least 80 vol %, at least 90 vol %, or all) of the plurality of particles in the first solid powder. Combinations of the above-referenced ranges are possible (e.g., greater than or equal to 0.1 times and less than or equal to 10 times). Other ranges are also possible.

In certain embodiments, it may be advantageous to produce a relatively turbulent flow within the volume (e.g., a volume contained by a reactor, a reaction volume) to allow for intensive mixing and heat transfer between the powders. For example, according to certain embodiments, the impeller employed to induce mixing of the powders may have a relatively high rotational speed. For example, in some embodiments, the impeller may have a rotational speed of greater than or equal to 10 revolutions per minute (RPM), greater than or equal to 20 RPM, greater than or equal to 50 RPM, greater than or equal to 80 RPM, greater than or equal to 100 RPM, greater than or equal to 200 RPM (and/or up to 500 RPM, up to 750 RPM, up to 1000 RPM, or more). Combinations of the above-referenced ranges are possible (e.g., greater than or equal to 10 RPM and up to 1000 RPM, greater than or equal to 50 RPM and up to 750 RPM, greater than or equal to 100 RPM and up to 500 RPM). Other ranges are also possible.

The solid powders may be heated and/or mixed for any of a variety of appropriate time durations, such as at least 0.5 hours, at least 1 hours, at least 2 hours, at least 4 hours, and/or up to 6 hours, up to 8 hours, up to 10 hours, up to 12 hours, or more. Combinations of the above-referenced ranges are possible (e.g., at least 0.5 hours and up to 12 hours, at least 1 hour and up to 10 hours, at least 2 hours and up to 8 hours, etc.).

In some embodiments, a turbulent mixing of the solid powders may be achieved within the volume (e.g., a volume contained by a reactor, such as a reaction volume). In general, the turbulence of mixing may be characterized by a dimensionless number, e.g., the Reynolds number (Re). In some embodiments, the Reynolds number (using the diameter of the mixer as the characteristic dimension) may be greater than or equal to 2,000, greater than or equal to 3,000, greater than or equal to 4,000, or more. The Reynolds number may be calculated as follows:

$$Re = \frac{uL}{ν} = \frac{ρ uL}{μ}$$

where ρ is the density of the fluid; u is the flow speed; L is the characteristic linear dimension; μ is the dynamic viscosity of the fluid; and v is the kinematic viscosity of the fluid.

In accordance with some embodiments, the first solid powder and the second solid powder may be mixed within the volume (e.g., the volume in which heating and/or mixing of solid powders takes place, a volume contained by a reactor) and/or heated to a temperature therein such that the first solid powder and the second solid powder react in a solid-phase reaction to form a product. For example, in some cases, a product may be formed upon continuous mixing of the first solid powder and the second solid powder. As shown in FIG. 1B, upon mixing (e.g., continuous mixing), first solid powder 20 and second solid powder 30 have reacted in a solid-phase reaction to form product 40. It is so possible for a product to be formed upon heating a first solid powder and a second solid powder in the absence of mixing and/or upon both heating and mixing together.

In some embodiments, the product comprises a metal halide. In some embodiments, the product is water soluble. The metal halide may comprise one or more target metals and/or types of cations initially contained within the first solid powder, and one or more halogens (e.g., halides) initially contained with the second solid powder. For example, in one set of embodiments, a first solid powder (e.g., zinc sulfide) comprising a transition metal (e.g., zinc) may react with a second solid powder comprising a halogen to form a metal halide (e.g., zinc halide).

In some embodiments, as described elsewhere herein, the solid-phase reaction between the first solid powder and the second solid powder (and/or the heating and/or mixing thereof) may be carried out in a substantially dry environment (e.g., such as containing less than 1 wt % liquid).

In some embodiments, the solid-phase reaction between the first solid powder and the second solid powder (and/or the heating and/or mixing thereof) may be carried out under an inert atmosphere. For example, an inert gas may be introduced into the volume (e.g., the volume in which heating and/or mixing of solid powders takes place, a volume contained by a reactor) prior to and/or during the mixing and/or the heating of the solid powders. Any of a variety of suitable inert gases may be used, including, but not limited to, argon, air, carbon dioxide, nitrogen, etc.

In some embodiments, the first solid powder and the second solid powder may be mixed, heated, and/or reacted in a closed volume, such as a closed volume contained by a reactor. A closed volume may be a volume that is not in fluidic communication with the external environment. For example, after introducing the first solid powder and the second solid powder into the volume, the volume may be sealed from the external environment by any appropriate means (e.g., via a lid, a cover, etc.). Within the closed volume, the first solid powder and the second solid powder may be mixed, heated, and/or reacted to form a product.

It is also possible for the first solid powder and the second solid powder may be mixed, heated, and/or reacted in an open volume, such as an open volume contained by a reactor. An open volume may be a volume that is in fluidic communication with the external environment. For example, after introducing the first solid powder and the second solid powder into the volume, fluidic communication may be maintained between the volume and the external environment. One manner of performing a reaction in an open volume is to perform a reaction in a reactor that is unsealed but lidded. Another manner of performing a reaction in an open volume is to perform the reaction in an open reactor (e.g., a reactor lacking a lid or for which the lid is held in an open position). Within the open volume, the first solid powder and the second solid powder may be mixed, heated, and/or reacted to form a product.

In some embodiments, the first solid powder and the second solid powder are mixed, heated, and/or reacted in a volume that is capable of releasing and/or configured to release one or more materials to an environment external to the reactor. For instance, the first solid powder and the second solid powder may be mixed, heated, and/or reacted in a volume that is capable of exhausting and/or configured to exhaust one or more materials to an environment external to the reactor. For instance, in some embodiments, the first solid powder and the second solid powder are mixed, heated, and/or reacted in a volume that is separated from an environment external to the reactor by a check valve that is positioned to allow flow from the volume to the environment external to the reactor but not from the environment external to the reactor to the volume. Volumes bounded in the above-described manners may be desirable when a material is generated inside the reactor that would engage in undesirable reactions with one or more other materials also present inside the reactor (e.g., a first salt, a second salt, one or more types of cations, one or more types of anions). One non-limiting example of such a material is ammonia, which may be generated when the second salt comprises an ammonium cation.

The solid-phase reaction (and/or the heating and/or mixing) described herein may be carried out for any of a variety of appropriate time durations, such as at least 0.5 hours, at least 1 hour, at least 2 hours, at least 4 hours, and/or up to 6 hours, up to 8 hours, up to 10 hours, up to 12 hours, or more. Combinations of the above-referenced ranges are possible (e.g., at least 0.5 hours and up to 12 hours, at least 1 hour and up to hours, at least 2 hours and up to 8 hours, etc.).

The solid-phase reaction (and/or the heating and/or mixing) described herein may be carried out at any of a variety of appropriate temperatures. In other words, a mixture comprising two solid powders may be heated to such a variety of temperatures, such as a temperature of greater than or equal to 100° C., greater than or equal to 125° C., greater than or equal to 150° C., greater than or equal to 175° C., greater than or equal to 200° C., greater than or equal to 250° C., greater than or equal to 400° C., greater than or equal to 600° C., or greater than or equal to 800° C., or more, and/or less than or equal to 1000° C., less than or equal to 800° C., less than or equal to 600° C., less than or equal to 500° C., less than or equal to 400° C., less than or equal to 200° C., less than or equal to 175° C., less than or equal to 150° C., less than or equal to 125° C., or less. Combinations of the above-referenced ranges are possible (e.g., greater than or equal to 100° C. and less than or equal to 1000° C., greater than or equal to 150° C. and less than or equal to 600° C., greater than or equal to 175° C. and less than or equal to 400° C., etc.).

The solid-phase reaction (and/or the heating and/or mixing) may be carried out under any of a variety of suitable pressures. In some embodiments, the solid-phase reaction may be carried out under a pressure of greater than or equal to 0.1 atmospheres absolute, greater than or equal to 0.5 atmospheres absolute, greater than or equal to 1 atmosphere absolute, greater than or equal to 5 atmospheres absolute, greater than or equal to 8 atmospheres absolute, greater than or equal to 10 atmospheres absolute, or more, and/or less than or equal to 15 atmospheres absolute, less than or equal to 8 atmospheres absolute, less than or equal to 5 atmospheres absolute, less than or equal to 1 atmosphere absolute, less than or equal to 0.5 atmospheres absolute, or less. Combinations of the above-reference ranges are possible (e.g., greater than or equal to 0.1 atmospheres absolute and less than or equal to 15 atmospheres absolute, greater than or equal to 0.5 atmospheres absolute and less than or equal to 8 atmospheres absolute, or greater than or equal to 1 atmosphere absolute and less than or equal to 5 atmospheres absolute). Other ranges are also possible.

The solid-phase reaction (and/or the heating and/or mixing) may be carried out under atmospheres having a variety of suitable O₂ concentrations. In other words, a mixture comprising two solid powders may be heated and/or mixed in the presence of an atmosphere having a variety of suitable O₂ concentrations. In some embodiments, the atmosphere has an O₂ concentration of less than or equal to 23 wt %, less than or equal to 20 wt %, less than or equal to 15 wt %, less than or equal to 10 wt %, less than or equal to 7.5 wt %, less than or equal to 5 wt %, less than or equal to 2.5 wt %, less than or equal to 1 wt %, less than or equal to 0.75 wt %, less than or equal to 0.5 wt %, less than or equal to 0.2 wt %, or less than or equal to 0.1 wt %. In some embodiments, the atmosphere has an O₂ concentration of greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, or greater than or equal to 20 wt %. In some embodiments, the atmosphere has an O₂ concentration of exactly 0 wt %. Combinations of the above-referenced ranges are also possible (e.g., less than or equal to 23 wt % and greater than or equal to 0 wt %, or less than or equal to 5 wt % and greater than or equal to 0 wt %). Other ranges are also possible.

Without wishing to be bound by any particular theory, it is believed that the presence of O₂ may negatively affect the formation of metal halides. It is believed that the presence of O₂ may result in the presence of free oxygen, which undesirably results in the formation of oxyhalides and/or suppresses halide formation.

The solid-phase reaction (and/or the heating and/or mixing) may be carried out under atmospheres having a variety of suitable concentrations of steam. In other words, a mixture comprising two solid powders may be heated and/or mixed in the presence of an atmosphere having a variety of suitable concentrations of steam. In some embodiments, the atmosphere has a concentration of steam of less than or equal to 5 wt %, less than or equal to 2.5 wt %, less than or equal to 1 wt %, less than or equal to 0.75 wt %, less than or equal to 0.5 wt %, less than or equal to 0.2 wt %, or less than or equal to 0.1 wt %. In some embodiments, the atmosphere has a concentration of steam of greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, or greater than or equal to 2 wt %. In some embodiments, the atmosphere has a concentration of steam of exactly 0 wt %. Combinations of the above-referenced ranges are also possible (e.g., less than or equal to 5 wt % and greater than or equal to 0 wt %, or less than or equal to 2 wt % and greater than or equal to 0 wt %). Other ranges are also possible.

Without wishing to be bound by any particular theory, it is believed that the presence of steam may negatively affect the formation of metal halides. It is believed that the presence of steam may result in the presence of free oxygen, which is undesirable for the reasons noted above with respect to O₂. It is also believed that other oxygen-containing solvents (e.g., oxygen-containing organic solvents, such as alcohols) may also exhibit similar effects.

The solid-phase reaction (and/or the heating and/or mixing) may be carried out under atmospheres having a variety of suitable concentrations of basic gases. In other words, a mixture comprising two solid powders may be heated and/or mixed in the presence of an atmosphere having a variety of suitable concentrations of basic gases. In some embodiments, the atmosphere has a concentration of basic gases of less than or equal to 15 wt %, less than or equal to 10 wt %, less than or equal to 7.5 wt %, less than or equal to 5 wt %, less than or equal to 2.5 wt %, less than or equal to 1 wt %, less than or equal to 0.75 wt %, less than or equal to 0.5 wt %, less than or equal to 0.2 wt %, or less than or equal to 0.1 wt %. In some embodiments, the atmosphere has a concentration of basic gases of greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, or greater than or equal to 10 wt %. In some embodiments, the atmosphere has a concentration of basic gases of exactly 0 wt %.

When an atmosphere in which a solid-phase reaction (and/or heating and/or mixing) comprises more than one type of basic gas, each type of basic gas may independently be present in an amount in one or more of the ranges provided above. It is also possible for all of the types of basic gases present to together be present in an amount in one or more of the ranges provided above.

One example of a type of basic gas is ammonia. Without wishing to be bound by any particular theory, it is believed that the presence of basic gases, such as ammonia, may negatively affect the formation of metal halides. Such gases may react with any free halides generated during the solid-phase reaction (and/or heating and/or mixing), preventing such halides from reacting with cations (e.g., first types of cations).

In some embodiments, while being mixed, the first solid powder and the second solid powder are simultaneously heated within the volume to a suitable temperature via a heater. It is also possible for solid powders to be heated in the absence of mixing. For example, in one set of embodiments, while being mixed or in the absence of mixing, the first solid powder and the second solid powder may be simultaneously heated to a maximum temperature of greater than or equal to 25° C., greater than or equal to 50° C., greater than or equal to 75° C., greater than or equal to 100° C., greater than or equal to 200° C., greater than or equal to 250° C., greater than or equal to 300° C., greater than or equal to 450° C., greater than or equal to 600° C., or greater than or equal to 750° C. In some embodiments, while being mixed or in the absence of mixing, the first solid powder and the second solid powder may be simultaneously heated to a maximum temperature of less than or equal to 900° C., less than or equal to 800° C., less than or equal to 750° C., less than or equal to 600° C., less than or equal to 500° C., less than or equal to 450° C., less than or equal to 300° C., less than or equal to 200° C., less than or equal to 100° C., less than or equal to 75° C., or less than or equal to 50° C. Combinations of the above-reference ranges are possible (e.g., greater than or equal to 25° C. and less than or equal to 900° C., greater than or equal to 50° C. and less than or equal to 450° C., or greater than or equal to 70° C. and less than or equal to 300° C.). Other ranges are also possible.

In some embodiments, the first solid powder and the second solid powder maybe heated (e.g., to a temperature in one or more of the ranges provided in the preceding paragraph) to a suitable temperature under any of a variety of suitable pressures. In some embodiments, the first solid powder and the second solid powder may be heated under a pressure of greater than or equal to 0.1 atmospheres absolute, greater than or equal to 0.5 atmospheres absolute, greater than or equal to 0.75 atmospheres absolute, greater than or equal to 1 atmosphere absolute, greater than or equal to 2 atmospheres absolute, greater than or equal to 5 atmospheres absolute, greater than or equal to 7 atmospheres absolute and/or less than or equal to 10 atmospheres absolute, less than or equal to 7 atmospheres absolute, less than or equal to 4 atmospheres absolute, less than or equal to 2 atmospheres absolute, less than or equal to 1 atmosphere absolute, less than or equal to 0.75 atmospheres absolute, and/or less than or equal to 0.5 atmospheres absolute. Combinations of the above-reference ranges are possible (e.g., greater than or equal to 0.1 atmospheres absolute and less than or equal to 10 atmospheres absolute, greater than or equal to 0.5 atmospheres absolute and less than or equal to 4 atmospheres absolute, or greater than or equal to 0.75 atmospheres absolute and less than or equal to 2 atmospheres absolute). Other ranges are also possible.

In some embodiments, after the first powder and the second powder react via a solid-phase reaction to form a product, the product may be recovered. This may be accomplished by separating a metal halide from any unreacted first solid powder and/or second solid powder. The metal halide may be the product or may be removed from the product via one or more of the processes described below. In some cases, the product and/or material to be removed from the product may be water soluble, e.g., such as in the form of a water-soluble metal halide. Additional downstream processing may be subsequently performed on the water-soluble metal halide, product, and/or material to be removed from the product. For example, in some such cases, one or more washing steps may be carried out (either within the volume of the reactor or external the reactor) using an aqueous system to dissolve the water-soluble metal halide, such that the one or more target metals may be recovered. Further non-limiting examples of downstream processing that may occur include precipitation and solvent extraction. It is also possible to reduce an isolated metal halide by gaseous reduction, metallothermic reduction, and/or electrolytic reduction.

In some embodiments, an optional cooling step may be performed prior to recovering the product.

In some embodiments, the method described herein may result in a relatively high percentage (%) of metal recovery. For example, according to some embodiments, greater than or equal to 25 mol %, greater than or equal to 50 mol %, greater than or equal to 70 mol %, greater than or equal to 80 mol %, greater than or equal to 90 mol %, greater than or equal to 95 mol %, or more, and/or less than or equal to 95 mol %, less than or equal to 90 mol %, less than or equal to 80 mol %, less than or equal to 70 mol %, less than or equal to 50 mol %, or less, of the total amount of target metal(s) initially present within the target-metal containing material(s) may be recovered via solubilization of the product in an aqueous solution. In some embodiments, the amount of metal recovered may depend on the solubility of the product in aqueous solutions. For example, in some embodiments in which the product comprises transition metal halides having slight solubility in aqueous solutions, at least (or up to) 25 mol % of the metal(s) may be recovered. For another example, in embodiments in which the product comprises alkali metal halides and/or alkali earth metal halides, greater than (or up to) 95 mol % of the metal(s) may be recovered.

Alternatively or additionally, according to certain embodiments, the product may be recovered via distillation. Any of a variety of temperatures may be employed during distillation, such as greater than 500° C., greater than 600° C., greater than 700° C., or more. Any of a variety of appropriate solvents may be employed for distillation of the product. In some embodiments, greater than or equal to 45 mol %, greater than or equal to 50 mol %, greater than or equal to 70 mol %, greater than or equal to 80 mol %, greater than or equal to 90 mol %, greater than or equal to 95 mol %, or more, and/or less than or equal to 95 mol %, less than or equal to 90 mol %, less than or equal to 80 mol %, less than or equal to 70 mol %, less than or equal to 50 mol %, or less, of the total amount of target metal(s) initially present within the target-metal containing material(s) may be recovered via distillation. In some embodiments, the amount of metal recovered may depend on the type of product. For example, in some embodiments in which the product comprises transition metal halides, at least (or up to) 45 mol % of metals may be recovered. For another example, in embodiments in which the product comprises alkali metal halides and/or alkali earth metal halides, greater than (or up to) 95 mol % of the metal(s) may be recovered.

In some embodiments, a product (e.g., a target metal) may be recovered to a relatively high degree as evidenced by a separation factor with respect to one or more other components also present in a solid powder initially comprising the target metal (e.g., in a first salt). The separation factor for a target metal with respect to another material is defined as follows:

$$\frac{\frac{{[ Target Metal ]}_{Starting Matertial}}{{[ Other C omponent ]}_{Starting Matertal}}}{\frac{{[ Target Metal ]}_{P r o d uced Material}}{{[ Other Component ]}_{P r o d uced Material}}} ,$$

where the starting material is the material initially containing the target metal that is subject to a solid-state reaction, heating, and/or mixing (e.g., a first solid powder, a first salt) and where the produced material is the material produced by the solid-state reaction, heating, and/or mixing (e.g., a metal halide). The other component may be any component from which it is desirable to separate the target material, such as another type of cation also present in the target material.

In some embodiments, a component of a starting material has a separation factor with respect to another component thereof of greater than or equal to 1.3, greater than or equal to 1.4, greater than or equal to 1.5, greater than or equal to 1.6, greater than or equal to 1.7, greater than or equal to 1.8, greater than or equal to 1.9, greater than or equal to 2, greater than or equal to 3, greater than or equal to 4, greater than or equal to 5, greater than or equal to 7.5, greater than or equal to 10, greater than or equal to 20, greater than or equal to 50, greater than or equal to 75, greater than or equal to 100, greater than or equal to 200, greater than or equal to 500, greater than or equal to 750, or greater than or equal to 1000. In some embodiments, a component of a starting material has a separation factor with respect to another component thereof of less than or equal to 2000, less than or equal to 1000, less than or equal to 750, less than or equal to 500, less than or equal to 200, less than or equal to 100, less than or equal to 75, less than or equal to 50, less than or equal to 20, less than or equal to 10, less than or equal to 7.5, less than or equal to 5, less than or equal to 4, less than or equal to 3, less than or equal to 2, less than or equal to 1, less than or equal to 1.9, less than or equal to 1.8, less than or equal to 1.7, less than or equal to 1.6, less than or equal to 1.5, or less than or equal to 1.4. Combinations of the above-referenced ranges are also possible (e.g., greater than or equal to 1.3 and less than or equal to 2000). Other ranges are also possible.

When a starting material comprises three or more components, each component may independently have a separation factor with respect to another component in an amount in one or more of the ranges provided above. It is also possible for separation factors to be calculated with respect to multiple components present in a starting material with respect to one or more other components of the starting material (e.g., a separation factor may be calculated for the sum of two or more components in the starting material with respect to another component in the starting material, a separation factor may be calculated for the sum of two or more components in the starting material with respect to the sum of two or more other components in the starting material). Such separation factors may also fall within one or more of the ranges provided above.

It should be noted that it is also possible for one or more components to have a separation factor with respect to one or more other components that is in a range bounded by values that are the inverses of those provided above. As one example, one component may have a separation factor with respect to another of greater than or equal to 0.0005 and less than or equal to 0.77 (values that are the inverses of 2000 and 1.3, respectively).

### Example 1

This Example demonstrates the ability to form rare earth metal halides by reacting a rare earth metal oxide-containing material with ammonium chloride. The rare earth metals were subsequently recovered to a high degree by solubilizing the rare earth metal halides in water.

Synthetic rare earth magnet scrap and ammonium chloride powders were added to glass vessels. Each powder had a largest cross-sectional dimension of below 500 μm. The synthetic rare earth magnet scrap included neodymium, praseodymium, dysprosium, and terbium oxides. The weight of the synthetic rare earth metal scrap was 0.55 g. The molar ratio of the ammonium chloride to the rare earth metal oxides present in the synthetic rare earth magnet scrap varied from 3:1 to 12:1.

Then, the powders present in the glass vessel were mixed, heated, and subject to further processing. A high-viscosity mixer was added to the glass vessel. Next, the glass vessel was then heated to 250° C. while the mixer was employed to mix the powders. The glass vessel was held at temperature and the powders were mixed for 30 minutes. Then, the glass vessel was cooled, the powders were removed therefrom and mixed with water, and the resultant solutions were filtered.

The filtrate separation factors of terbium with respect to dysprosium for the various initial molar ratios of ammonium chloride to the rare earth metal oxides is shown below in Table 2.

TABLE 2
Separation factors of terbium with respect to dysprosium
for various initial molar ratios of ammonium chloride
to the rare earth metal oxides.

| Initial Molar Ratio of Ammonium | Separation Factor of Terbium with |
|---|---|
| Chloride to Rare Earth Metal Oxides | Respect to Dysprosium |
| 3:1 | 1.38 |
| 6:1 | 0.93 |
| 9:1 | 1.05 |
| 12:1 | 2.63 |
| 15:1 | 1.47 |

It is noted that the highest separation factor of terbium with respect to dysprosium was achieved for a 12:1 molar ratio ammonium chloride to the rare earth metal oxides.

### Example 2

This Example demonstrates the ability to form copper and iron halides by reacting a copper and iron sulfide-containing material with ammonium chloride. The copper and iron were subsequently recovered by solubilizing the copper and iron halides in water.

Chalcopyrite and ammonium chloride powders were added to a glass vessel. The weight of the chalcopyrite was 0.5 g. The molar ratio of the ammonium chloride to the chalcopyrite was 9:1.

Then, the powders present in the glass vessel were mixed, heated, and subject to further processing. A mixer was added to the glass vessel, and a lid was placed on the glass vessel but left unsealed. Next, the glass vessel was then heated to 250° C. while the mixer was employed to mix the powders. The glass vessel was held at temperature and the powders were mixed for 30 minutes. Then, the glass vessel was cooled, the powders were removed therefrom and mixed with 30 mL of water, and the resultant solutions were filtered.

The water exhibited an orange hue after mixing with the reacted powders. The mass of the powder remaining after filtration was appreciably less than 0.5 g, indicating that a portion of the copper and iron initially present therein formed halides during the mixing and heating.

### Example 3

This Example demonstrates the ability to form a zinc halide by reacting zinc oxide and zinc sulfide with calcium chloride. The zinc was subsequently recovered by solubilizing the zinc halide in water.

Zinc oxide, zinc sulfide, and calcium chloride powders were added to a glass vessel. The zinc oxide and zinc sulfide powders together had a weight of 0.3 g. The molar ratio of the calcium chloride to the zinc oxide and zinc sulfide was 9:1.

Then, the powders present in the glass vessel were mixed, heated, and subject to further processing. A mixer was added to the glass vessel, and a lid was placed on the glass vessel but left unsealed. Next, the glass vessel was then heated to 250° C. while the mixer was employed to mix the powders. The glass vessel was held at temperature and the powders were mixed for 30 minutes. During this time period, the mixed powders developed a yellow color. Then, the glass vessel was cooled, the powders were removed therefrom and mixed with 30 mL of water, and the resultant solutions were filtered.

The mass of the powder remaining after filtration was appreciably higher than 0.3 g, indicating that calcium hydroxide was formed during the mixing and heating.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of forming a rare earth metal halide, comprising:
heating a mixture comprising a first solid powder and a second solid powder, wherein:
the first solid powder comprises a first salt,
the first salt comprises a first type of cation and a first type of anion,
the first type of cation is a rare earth metal cation,
the second solid powder comprises a second salt,
the second salt comprises a second type of cation and a second type of anion,
the second type of anion is a halide, and
the rare earth metal halide comprises the first type of cation and the second type of anion.

2. The method of claim 1, further comprising mixing the first solid powder and the second solid powder.

3. The method of claim 2, wherein the mixing is performed with the use of a high-viscosity mixer.

4. A method of forming a metal halide, comprising:
mixing and heating a first solid powder and a second solid powder, wherein:
the first solid powder comprises a first salt,
the first salt comprises a first type of cation and a first type of anion,
the first type of cation is a rare earth metal cation, an aluminum cation, or a transition metal cation,
the second solid powder comprises a second salt,
the second salt comprises a second type of cation and a second type of anion,
the second type of anion is a halide,
the mixing is performed with the use of a high-viscosity mixer, and
the metal halide comprises the first type of cation and the second type of anion.

5. The method of claim 1, wherein the first salt comprises a third type of cation.

6. The method of claim 5, wherein the third type of cation is a rare earth metal cation, an aluminum cation, or a transition metal cation.

7. The method of claim 5, wherein less than or equal to 15 at % of the third type of cation initially present in the first salt is present in the metal halide.

8. A method of forming a metal halide, comprising:
heating a mixture comprising a first solid powder and a second solid powder, wherein:
the first solid powder comprises a first salt,
the first salt comprises a first type of cation and a first type of anion,
the second solid powder comprises a second salt,
the second salt comprises a second type of cation and a second type of anion,
the second type of anion is a halide,
the first salt comprises a third type of cation,
the third type of cation is a rare earth metal cation, an aluminum cation, or a transition metal cation,
the metal halide comprises the first type of cation and the second type of anion, and
less than or equal to 15 at % of the third type of cation initially present in the first salt is present in the metal halide.

9-30. (canceled)

31. A reactor, comprising:
a volume containing a first solid powder and a second solid powder, wherein:
the volume contains less than 1 wt % liquid, and
the first solid powder and the second solid powder are configured to react in a solid-phase reaction to form a product.

32. The reactor of claim 31, wherein the first solid powder comprises a first salt comprising a first type of cation and a first type of anion, and wherein the first type of cation comprises a rare earth metal cation, an aluminum cation, or a transition metal cation.

33. The reactor of claim 31, wherein the second solid powder comprises a second salt comprising a second type of cation and a second type of anion, and wherein the second type of anion is a halide.

34. The reactor of claim 32, wherein the first salt comprises a third type of cation.

35. The reactor of claim 34, wherein the third type of cation is a rare earth metal cation, an aluminum cation, or a transition metal cation.

36. The reactor of claim 34, wherein less than or equal to 15 at % of the third type of cation initially present in the first salt is present in the product.

37. (canceled)

38. The reactor of claim 31, wherein the reactor is configured to heat the first solid powder and the second solid powder.

39. The reactor of claim 31, further comprising a mixer configured to mix the first solid powder and the second solid powder within the volume.

40. The reactor of claim 31, further comprising a heater configured to heat the volume to a temperature such that the maximum temperature within the volume is greater than or equal to 25° C. and less than or equal to 900° C.

41. The reactor of claim 31, wherein the reaction volume contains less than 0.1 wt % of the liquid.

42. (canceled)

43. The reactor of claim 31, wherein at least 50 wt % of the first solid powder is made up of solid particles having largest cross-sectional dimensions of greater than or equal to 20 microns and less than or equal to 500 microns.

44. The reactor of claim 31, wherein at least 50 wt % of the second solid powder is made up of solid particles having largest cross-sectional dimensions of greater than or equal to 20 microns and less than or equal to 500 microns.

45-66. (canceled)
